(19) United States
(12) Patent Application Publication
(10) Pub. No.: US 2024/0382879 A1
(43) Pub. Date: Nov. 21, 2024

(54) FILTRATION SYSTEM

(71) Applicant: Saudi Arabian Oil Company, Dhahran (SA)

(72) Inventors: Abdullah Hajri, Dhahran (SA); Abdullatif Omair, Dammam (SA); Adel Alharbi, Al Hofuf (SA)

(21) Appl. No.: 18/198,132

(22) Filed: May 16, 2023

(51) Int. Cl. B01D 35/30; B01D 29/00

(52) U.S. Cl. CPC B01D 35/30; B01D 29/64

(57) ABSTRACT

A filtration assembly includes a tubular housing and a partition. The tubular housing has an inner volume, a first fluid inlet, a second fluid inlet, and a first fluid outlet. The partition resides within the tubular housing to divide the inner volume into a first volume and a second volume. The partition has a filter surface. The tubular housing directs, during filtration of a first fluid, the first fluid from the first fluid inlet to the first volume, from the first volume through the filter surface to the second volume, and from the second volume to the first fluid outlet. The tubular housing directs, during cleaning, a second fluid from the second fluid inlet to the second volume, through the second volume and the filter surface to the first volume, and from the first volume out of the tubular housing. The second fluid removes particles from the filter surface.

### TECHNICAL FIELD

This disclosure relates to filtration methods and equipment.

### BACKGROUND

Oil and gas production or processing often involves filtering fluids such as water or hydrocarbons. Some filtration systems include filtration skids. Filtration skids remove particles such as mud and other matter from fluids. Filtration skids often become clogged, which can reduce the efficiency of the system or lead to damaged equipment. Methods and equipment to improve filtration systems are sought.

### SUMMARY

Implementations of the present disclosure include a filtration assembly that includes a tubular housing and a partition. The tubular housing has an inner volume, a first fluid inlet, a second fluid inlet, and a first fluid outlet. The partition resides within the tubular housing to divide the inner volume into a first volume and a second volume. The partition comprising a filter surface, the tubular housing directs, during filtration of a first fluid, the first fluid from the first fluid inlet to the first volume, from the first volume through the filter surface to the second volume, and from the second volume to the first fluid outlet. The tubular housing directs, during backwash, a second fluid from the second fluid inlet to the second volume, through the second volume and the filter surface to the first volume, and from the first volume out of the tubular housing. The second fluid removes particles from the filter surface.

In some implementations, the second fluid inlet includes one or more nozzles and the second fluid reaches the filter surface at a speed substantially equal to a speed of the second fluid leaving the one or more nozzles. In some implementations, the one or more nozzles direct the second fluid toward the filter surface at a velocity sufficient to remove particles from the filter surface. In some implementations, the one or more nozzles includes multiple nozzles each facing a respective mesh of the filter surface.

In some implementations, the filter surface resides along a plane normal with respect to a flow direction of the second fluid entering the tubular housing.

In some implementations, the filter surface defines an inlet side facing the first volume and an outlet side facing the second volume and the second fluid inlet such that the second fluid flows straight from the second fluid inlet to the outlet side of the filter surface.

In some implementations, the second fluid includes water with chlorine, and the first fluid includes water or hydrocarbons or both flowed from a degassing drum.

In some implementations, the first fluid flows, during the filtration, in a first direction across the filter surface, and the second fluid flows, during the backwash, in a second direction across the filter surface, the second direction being opposite the first direction.

In some implementations, the tubular housing keeps, during the backwash, the first fluid within its inner volume at a level below the filter surface.

In some implementations, the tubular housing includes a vessel and the partition includes a rigid sheet disposed within and fixed to the vessel. The filter surface includes one or more filter meshes fixed to and coplanar with a section of the rigid sheet.

In some implementations, the one or more filter meshes includes multiple circular meshes spaced from each other.

In some implementations, the tubular housing defines a central longitudinal axis of the tubular housing. The partition includes a first portion on a plane substantially parallel to the central longitudinal axis and a second portion extending from the first portion at an angle of between 20° and 85° with respect to the plane.

In some implementations, the tubular housing includes a first fluid drain fluidly coupled to the first volume and a second fluid drain fluidly coupled to the second volume. At least one of the first fluid drain and the second fluid drain drains, during the backwash, at least one of the fluid or the second fluid from the inner volume.

Implementations of the present disclosure include a method that includes flowing a first fluid through a filtration system including a tubular housing including an internal partition dividing an inner volume of the tubular housing into a first volume and a second volume. The internal partition includes a filter surface. The tubular housing includes a first fluid inlet, a second fluid inlet, and a first fluid outlet. The flowing includes flowing the first fluid from the fluid inlet to the first volume, from the first volume through the filter surface to the second volume to filter the first fluid, and from the second volume to the fluid outlet. The method also includes flowing, during cleaning (or backwash) of the filtration system, a second fluid from the second fluid inlet to the second volume, from the second volume through the filter surface to the first volume to clean the filter surface, and from the first volume out the tubular housing.

In some implementations, flowing the second fluid includes flowing the second fluid such that the second fluid reaches the filter surface at a velocity sufficient to remove stuck particles from the filter surface.

In some implementations, the flowing of the second fluid includes flowing the second fluid while maintaining the first fluid within the inner volume at a level below the filter surface. In some implementations, flowing the second fluid includes flowing the second fluid while or after draining the first fluid from the tubular housing.

In some implementations, the filter surface defines an inlet side facing the first volume and an outlet side facing the second volume and the second fluid inlet, and flowing the second fluid includes flowing the second fluid straight from the second fluid inlet to the outlet side of the filter surface.

In some implementations, the method further includes, before flowing the second fluid, adding chlorine to the second fluid.

In some implementations, the second fluid inlet is fluidly coupled to one or more nozzles facing the filter surface, and flowing the second fluid includes jetting the second fluid from the one or more nozzles to the filter surface to remove particles from the filter surface.

Particular implementations of the subject matter described in this specification can be implemented so as to realize one or more of the following advantages. For example, the filtration system can minimize or eliminate blockage events, prevent the formation of pinholes in the piping system, and increase the reliability of the filtration system. The filtration system can also ensure uniform fluidization, which can prevent pumps from being damaged. Additionally, the filtration system does not have filters that need to be changed and can be cleaned without (or with minimal) human involvement, which can save time and resources.

### BRIEF DESCRIPTION OF THE DRAWINGS

FIG. 1 is a perspective schematic view, partially cross-sectional, of a filtration system according to an embodiment of the present disclosure.

FIG. 2 is a front, cross sectional view of the filtration system in FIG. 1 during filtration.

FIG. 3 is a front, cross sectional view of the filtration system in FIG. 1 during backwash.

FIG. 4 is a flow chart of a method of cleaning a filtration system.

### DETAILED DESCRIPTION

The present disclosure describes a filtration system that includes a filtration vessel. In some aspects, the vessel has an internal rigid sheet that divides the inner volume of the vessel. The rigid sheet has a horizontal section with a filter surface and a sloped section. During filtration, the fluid (for example, Monoethylene Glycol (MEG), water, hydrocarbons, or) enters the vessel, flows up through the filter surface, and flows down through the sloped section to the outlet of the vessel. In some aspects, during the backwash of the vessel, the flow of fluid is reversed so that the filtered fluid enters the skid through the second inlet and leaves the vessel through the drain. The vessel also receives clean water that is flowed through nozzles straight to the filter surface to clean the filter surface.

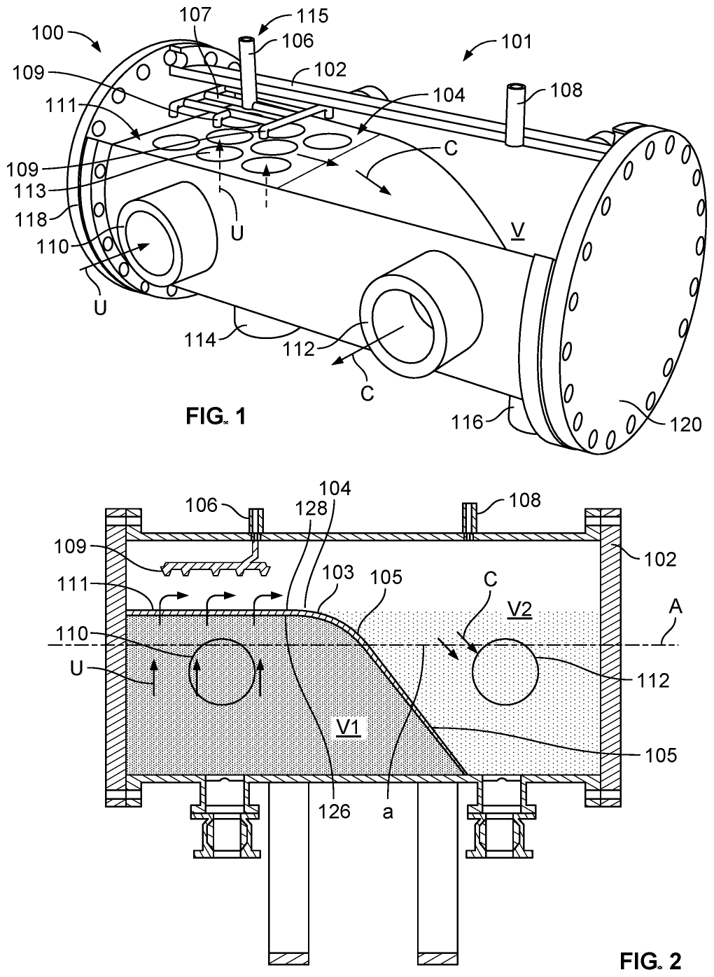

FIG. 1 shows a filtration system 100 or assembly that includes a vessel 101. The vessel 101 can be part of a filtration skid used in different filtration systems such as gas coalescing filters, gas filter separators, or liquid particle filters. For example, the vessel can be part of a filtration skid that receives unfiltered MEG from a degassing drum (not shown) and flows the filtered MEG to a cold stripper or a pre-treatment vessel (not shown).

The vessel 101 includes a tubular housing 102 (for example, a 30-inch pipe) and a partition 104 inside the housing 102. The housing 102 can be made of metal such as stainless steel or carbon steel. The housing 102 has two flanges 118, 120 at opposite ends of the housing 102. The flanges 118, 120 can be, for example, blind flanges, Klein Flansche (KF) flanges, or quick flange (QF) flanges.

The partition 104 can be configured as a rigid sheet fixed (for example, welded or fastened) to the interior wall of the vessel 101. The partition 104, for example, has a first portion 103 (for example, a horizontal surface) and a second portion 105 (for example, a sloped surface). The first portion 103 has a filter surface 111 coplanar with the first surface 103. The filter surface 111 can be made of one or more filter meshes 113 (for example, circular meshes) fixed to the first surface 103. The filter surface 111 can have between one and 20 (for example, eight) filter meshes 113 each spaced from each other. The filter meshes 113 retain particles (for example, mud, debris, or other carryover particles) as fluid flows through the meshes 113 to filter the fluid. The filter meshes 113 can be made of a hard material such as plastic or metal.

In some aspects, the housing 102 has a fluid inlet 110, a fluid outlet 112, and a second fluid inlet 106. The second fluid inlet 106 is part of a backwash assembly 115 that includes a manifold 107 and one or more nozzles 109 that flow a cleaning fluid (for example, pressurized air or chlorinated water) toward the filter surface 111. The second fluid inlet 106 is fluidly connected to the internal manifold 107 that directs fluid from the second fluid inlet 106 to multiple nozzles 109 each pointing at one or more of the filter meshes 113. For example, the vessel 101 can have eight nozzles 109 and each nozzle can jet fluid to a respective one of the eight filter meshes 113.

In some aspects, the housing 102 defines an inner volume “V” that receives an unclean or unfiltered fluid “U.” The unfiltered fluid “U” flows through the filter surface 111 and leaves the vessel 101 as a clean or filtered fluid “C” through the fluid outlet 112. During the filter process, the pressure at the inlet 110 can be monitored to determine when the vessel 101 needs to be cleaned.

Referring also to FIG. 2, the partition 104 resides within the housing 102 and divides the inner volume “V” into a first volume “V1” and a second volume “V2.” The first volume “V1” is fluidly coupled to the inlet 110 and the second volume “V2” is fluidly coupled to the outlet 112. The first volume “V1” is spaced from the second volume “V2” by the partition 104 and the filter surface 111. The nozzles 109 reside within the second volume “V2” and flow, during backwash, fluid from the second volume “V2” to the first volume “V1” through the filter surface 111.

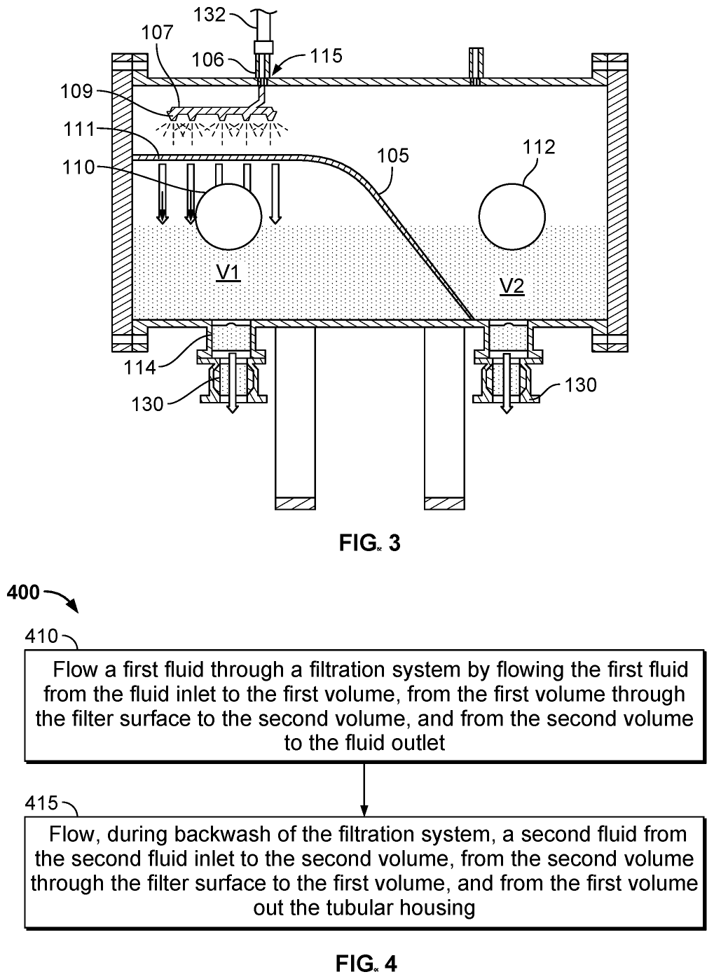

During filtration, the unfiltered fluid “U” flows from the inlet 110 into the first volume “V1” and from the first volume “V1” through the filter surface 111 to the second volume “V2.” The filtered fluid “C” flows from the second volume “V2” out of the vessel through the fluid outlet 112. As further described in detail below with respect to FIG. 3, during backwash, the flow direction of the fluid can be reversed while clean water is jetted through the nozzles 109 to clean the filter surface 111.

In some aspects, the housing 102 defines a central longitudinal axis “A.” The filter surface 111 resides on a plane that is parallel (or generally parallel) to the central longitudinal axis “A.” Also, the plane of the filter surface 111 is normal with respect to a flow direction of the clean water that enters the tubular housing through the second inlet 106. For example, the jetted fluid from the nozzles 109 can flow in a direction that is perpendicular to the plane of the filter surface 111. In some cases, the jetted fluid can flow at an angle with respect to the filter surface 111. The filter surface 111 has an inlet side 126 facing the first volume “V1” and an outlet side 128 facing the second volume “V2.” The outlet side 128 also faces the second fluid inlet 106 such that the second fluid flows straight from the second fluid inlet to the outlet side 128 of the filter surface.

In some aspects, the second portion 105 of the partition 104 extends from the first portion 103 at an angle “a” of between 20° and 85° (for example, 45°) with respect to the central plane or the axis “A.” During filtration, the filtered fluid “C” flows down the second portion 105 to flow out the outlet 112. During the backwash process, fluid flows up the sloped section 105 and down to the drains 114, 116 to exit the vessel. The sloped section increases the size of the first volume (as opposed to a vertical second section), which allows more mud to accumulate under the filter surface before blockage occurs.

In some aspects, the vessel 101 also has fluid drains 114, 116. One fluid drain 114 is fluidly coupled to the first volume “V1” and the second fluid drain 116 is fluidly coupled to the second volume “V2.” The fluid drains 114, 116 allow the vessel 101 to be drained during the backwash process. In some aspects, one or both of the drains 114, 116 are connected to an industrial “close drain system” that drains slugs to a safe region. The vessel 101 also includes a vent 108 (for example, a vent with a pressure-release valve) that helps maintain the vessel at a desirable pressure.

As shown in FIG. 3, to clean the filter system 100, the vessel 101 can be backwashed by reversing the flow and using the backwash assembly 115. For example, to clean the filter surface 111, the backwash assembly 115 flows fluid to the filter surface 111 to remove any particles stuck in the filter surface 111. During backwash, the first fluid can be maintained within the inner volume at a level below the filter surface.

To use the backwash assembly 115, an operator can connect a utility water hose 132 to the second fluid inlet 106. The utility water hose 132 is connected to a clean water source such as a water tank or utility water line. The water flowed into the backwash assembly can be mixed with chlorine. The chlorine content in the clean water can be, for example, between 0.5 and 2 ppm. Once connected, the utility water hose 132 flows the clean water to the inlet 106 and to the manifold 107 that distributes the water to the multiple nozzles 109. The nozzles 109 jet water at a fluid velocity sufficient to remove all or most particles from the filter surface 111. For example, the water flows at a velocity of between 1.5 and 50 meters per second (m/s) from the nozzles 109 to the filter surface 111, such as between 1.5 and 10 m/s or 1.5 and 3 m/s. Also, the water can flow directly or straight from the nozzles 109 to the filter surface 111 (for example, without the first fluid being between the nozzles and the filter surface). The water can flow in a direction perpendicular to the filter surface 111 or at an angle with respect to the filter surface 111.

In some aspects, the filter surface 111 resides proximate the nozzles 109. For example, the filter surface 111 can be spaced from the nozzles a distance of between 10 and 15 inches so that the clean water reaches the filter surface at a speed substantially equal to the speed of the second fluid leaving the nozzles 109. The jetted fluid flows from the nozzles and through the filter surface 111 in a direction opposite the direction of the fluid during filtration. The jetted water helps remove stuck particles from the filter surface 111 without needing manual cleaning. Also, during backwash, valves 130 connected to the drains 114, 116 can be opened to allow fluid and particles to flow out of the vessel.

Additionally, the backwash assembly 115 can be used alone. For example, upon determining that the filter surface 111 needs cleaning, the pumps flowing fluid into the vessel can be shut off and the vessel drained. Then, the backwash assembly 115 can jet the clean water (for example, the backwash water) to the filter surface 111 to clean the filter surface 111. The backwash water creates a uniform slurry mixture, which can be removed through the drain 114 at the bottom of the vessel. Once the filter surface 111 is clean, the filtering process can be resumed.

FIG. 4 shows a flow chart of a method (400) that includes flowing a first fluid through a filtration system comprising a tubular housing comprising an internal partition dividing an inner volume of the tubular housing into a first volume and a second volume. The tubular housing has a first fluid inlet, a second fluid inlet, and a first fluid outlet. The flowing includes flowing the first fluid from the fluid inlet to the first volume, from the first volume through the filter surface to the second volume to filter the first fluid, and from the second volume to the fluid outlet (405). The method also includes flowing, during backwash of the filtration system, a second fluid from the second fluid inlet to the second volume, from the second volume through the filter surface to the first volume to clean the filter surface, and from the first volume out the tubular housing (410).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A filtration assembly, comprising:
a tubular housing that comprises an inner volume, a first fluid inlet, a second fluid inlet, and a first fluid outlet; and
a partition configured to reside within the tubular housing to divide the inner volume into a first volume and a second volume, the partition comprising a filter surface, the tubular housing configured to direct, during filtration of a first fluid, the first fluid from the first fluid inlet to the first volume, from the first volume through the filter surface to the second volume, and from the second volume to the first fluid outlet, and the tubular housing is configured to direct a second fluid from the second fluid inlet to the second volume, through the second volume and the filter surface to the first volume, and from the first volume out of the tubular housing, the second fluid configured to remove particles from the filter surface.

2. The filtration assembly of claim 1, wherein the second fluid inlet comprises one or more nozzles and the second fluid reaches the filter surface at a speed substantially equal to a speed of the second fluid leaving the one or more nozzles.

3. The filtration assembly of claim 2, wherein the one or more nozzles are configured to direct the second fluid toward the filter surface at a velocity sufficient to remove particles from the filter surface.

4. The filtration assembly of claim 2, wherein the one or more nozzles comprises a plurality of nozzles each facing a respective mesh of the filter surface.

5. The filtration assembly of claim 1, wherein the filter surface resides along a plane normal with respect to a flow direction of the second fluid entering the tubular housing.

6. The filtration assembly of claim 1, wherein the filter surface defines an inlet side facing the first volume and an outlet side facing the second volume and the second fluid inlet such that the second fluid flows straight from the second fluid inlet to the outlet side of the filter surface.

7. The filtration assembly of claim 1, wherein the second fluid comprises water with chlorine, and the first fluid comprises water or hydrocarbons or both flowed from a degassing drum.

8. The filtration assembly of claim 1, wherein the first fluid flows, during the filtration, in a first direction across the filter surface, and the second fluid flows, during backwash, in a second direction across the filter surface, the second direction being opposite the first direction.

9. The filtration assembly of claim 1, wherein the tubular housing is configured to keep, during backwash, the first fluid within its inner volume at a level below the filter surface.

10. The filtration assembly of claim 1, wherein the tubular housing comprises a vessel and the partition comprises a rigid sheet disposed within and fixed to the vessel, the filter surface comprising one or more filter meshes fixed to and coplanar with a section of the rigid sheet.

11. The filtration assembly of claim 10, wherein the one or more filter meshes comprises a plurality of circular meshes spaced from each other.

12. The filtration assembly of claim 1, wherein the tubular housing defines a central longitudinal axis of the tubular housing, the partition comprising a first portion on a plane substantially parallel to the central longitudinal axis, and a second portion extending from the first portion at an angle of between 20° and 85° with respect to the plane.

13. The filtration assembly of claim 1, wherein the tubular housing comprises a first fluid drain fluidly coupled to the first volume and a second fluid drain fluidly coupled to the second volume, at least one of the first fluid drain and the second fluid drain configured to drain at least one of the fluid or the second fluid from the inner volume during backwash.

14. A method, comprising:
flowing a first fluid through a filtration system comprising a tubular housing comprising an internal partition dividing an inner volume of the tubular housing into a first volume and a second volume, the internal partition comprising a filter surface, the tubular housing comprising a first fluid inlet, a second fluid inlet, and a first fluid outlet, the flowing comprising flowing the first fluid from the fluid inlet to the first volume, from the first volume through the filter surface to the second volume to filter the first fluid, and from the second volume to the fluid outlet; and
flowing, during cleaning of the filtration system, a second fluid from the second fluid inlet to the second volume, from the second volume through the filter surface to the first volume to clean the filter surface, and from the first volume out the tubular housing.

15. The method of claim 14, wherein flowing the second fluid comprises flowing the second fluid such that the second fluid reaches the filter surface at a velocity sufficient to remove stuck particles from the filter surface.

16. The method of claim 14, wherein the flowing of the second fluid comprises flowing the second fluid while maintaining the first fluid within the inner volume at a level below the filter surface.

17. The method of claim 16, wherein flowing the second fluid comprises flowing the second fluid while or after draining the first fluid from the tubular housing.

18. The method of claim 14, wherein the filter surface defines an inlet side facing the first volume and an outlet side facing the second volume and the second fluid inlet, and flowing the second fluid comprises flowing the second fluid straight from the second fluid inlet to the outlet side of the filter surface.

19. The method of claim 14, further comprising, before flowing the second fluid, adding chlorine to the second fluid.

20. The method of claim 14, wherein the second fluid inlet is fluidly coupled to one or more nozzles facing the filter surface, and flowing the second fluid comprises jetting the second fluid from the one or more nozzles to the filter surface to remove particles from the filter surface.
